(19) United States
(12) Patent Application Publication
(10) Pub. No.: US 2025/0282004 A1
(43) Pub. Date: Sep. 11, 2025

(54) LASER CONDITIONING METHOD FOR NONLINEAR OPTICAL CRYSTAL

(71) Applicant: LASER FUSION RESEARCH CENTER OF CAEP, Mianyang, Sichuan (CN)

(72) Inventors: Wei HONG, Mianyang, Sichuan (CN); Liening WEI, Mianyang, Sichuan (CN); Wanguo ZHENG, Mianyang, Sichuan (CN); Xiangyang LEI, Mianyang, Sichuan (CN); Qihua ZHU, Mianyang, Sichuan (CN); Xiangxu CHAI, Mianyang, Sichuan (CN); Jingqin SU, Mianyang, Sichuan (CN); Xiaodong JIANG, Mianyang, Sichuan (CN); Song ZHOU, Mianyang, Sichuan (CN); Xinda ZHOU, Mianyang, Sichuan (CN); Hongjie LIU, Mianyang, Sichuan (CN); Yinbo ZHENG, Mianyang, Sichuan (CN); Weimin ZHOU, Mianyang, Sichuan (CN); Zhimeng ZHANG, Mianyang, Sichuan (CN); Jin HUANG, Mianyang, Sichuan (CN); Bo CUI, Mianyang, Sichuan (CN); Lingbiao MENG, Mianyang, Sichuan (CN)

(21) Appl. No.: 18/689,542

(22) PCT Filed: Jan. 18, 2024
(86) PCT No.: PCT/CN2024/073043

§ 371 Date: May 29, 2025

(30) Foreign Application Priority Data
Aug. 29, 2023 (CN) 2023111039428

(51) Int. Cl. B23K 26/50; B23K 26/0622

(52) U.S. Cl. CPC B23K 26/50; B23K 26/0624

(57) ABSTRACT

Provided is a laser conditioning method for a nonlinear optical crystal, including the following steps: irradiating the nonlinear optical crystal by a laser, wherein the laser has a photon energy of Eg/2 to Eg, Eg being a band gap of the nonlinear optical crystal

### CROSS-REFERENCE TO RELATED APPLICATION

This application is a national stage application of International Patent Application No. PCT/CN2024/073043 filed on Jan. 18, 2024, which claims the benefit and priority of Chinese Patent Application No. 202311103942.8 entitled “Laser conditioning method for nonlinear optical crystal” filed with the China National Intellectual Property Administration on Aug. 29, 2023. The disclosures of the two applications each are incorporated by reference herein in its entirety as part of the present application.

### TECHNICAL FIELD

The present disclosure belongs to the technical field of laser conditioning, and in particular relates to a laser conditioning method for a nonlinear optical crystal.

### BACKGROUND

Nonlinear artificial crystal is an essential key optical element in both lasers and large-scale intense laser devices. Potassium dihydrogen phosphate (KDP) nonlinear optical crystal and other similar crystals with similar lattice structures, such as deuterated potassium dihydrogen phosphate (DKDP) with different deuterated ratios and ammonium dihydrogen phosphate (ADP), are important nonlinear artificial crystals which are widely used at present. These crystals are usually used as frequency doubling elements or electro-optical switching elements in laser devices and need to be exposed to intense laser radiation frequently. When the laser intensity I (in unit of W/cm²) irradiated on the crystal surface is greater than a certain threshold (bulk damage threshold Iₜₕ), the laser will result in irreversible damage inside the crystal, so that the nonlinear artificial crystal loses its due basic function, thus making the laser lose its function. Therefore, the ability of the KDP and its similar crystals to resist intense laser damage, that is, the magnitude of the bulk damage threshold Iₜₕ, is one of its very important performance indicators.

In order to improve the ability of the KDP and its similar crystals to resist intense laser damage, a technology referred to as laser conditioning has been developed in the past 40 years. The basic method of such technology is that the bulk damage threshold of the unconditioned KDP and its similar crystals is assumed to be I_{th_i}, and if the crystal is directly irradiated by the laser with a laser intensity greater than I_{th_i}, an irreversible bulk damage will occur in the crystal. However, the crystal could be irradiated with a certain number of pulses by using a laser with a laser intensity less than I_{th_i}, such as a laser with an intensity of 0.5 times I_{th_i}, and then the crystal will not be damaged when the crystal is subsequently irradiated by using a laser with an intensity of I_{th_i}. Such method of increasing the laser bulk damage threshold Iₜₕ is referred to as the laser conditioning technology of the KDP and its similar crystals. Taking DKDP crystal as an example, the I_{th_i} of the crystal grown by using the highest-level crystal growth technology at present is about 4 J/cm₂/3 ns. After conditioning by using the laser with a wavelength of 355 nm, the Iₜₕ of the crystal could be increased to about 8 J/cm²/3 ns. In practice, in order to obtain an optimal conditioning effect, through the optimization of laser parameters, it is found that the conditioning effect is strongly dependent on the conditioned laser intensity for the laser with a wavelength of 355 nm. The stronger the laser, the better the conditioning effect. However, the laser should not be too strong, otherwise it would directly damage the crystal. The laser intensity with the optimal conditioning effect is about 5 GW/cm².

“Off-Line Sub-Nanosecond Laser Conditioning Technology On Large-Aperture Deuterated Potassium Dihydrogen Phosphate Crystals” (Liu Zhichao et al., Acta Phys. Sin., Vol. 70, No. 7 (2021), 074208) discloses the laser conditioning technology for KDP/DKDP crystals by using a triple-frequency laser (with a wavelength of 355 nm) output by the Nd: YAG laser device. The conditioning experimental parameters are as follows: a pulsed laser applied to the DKDP crystal to be conditioned has a pulse width of 0.5 nanoseconds, a spot diameter of 0.68 mm, a wavelength of 355 nm, a maximum conditioned laser fluence of 2 J/cm², and a maximum laser power density of 4 GW/cm². Sub-nanosecond laser conditioning could increase the zero-probability bulk damage threshold of the DKDP crystal by about one time.

However, due to the limited laser energy output by the pulse laser, in order to achieve the laser intensity of 4 GW/cm² to 5 GW/cm² required for conditioning technology, the laser spot could only be reduced to a diameter less than 1 mm (0.68 mm as reported in the above document). Considering a maximum repetition frequency of the energy output by the pulse laser, the surface area of the crystal that could be conditioned by laser conditioning per hour is only about 20 cm² at present in terms of conditioning efficiency.

To sum up, the current laser conditioning technology for the KDP and its similar crystals has deficiencies of low conditioning efficiency and high conditioning cost.

### SUMMARY

The present disclosure aims to provide a laser conditioning method for a nonlinear optical crystal based on two-photon absorption. The laser conditioning method according to the present disclosure could greatly and efficiently improve a laser bulk damage threshold of nonlinear optical crystal and reduce a conditioning cost.

To achieve the above object, the present disclosure provides the following technical solutions.

The present disclosure provides a laser conditioning method for a nonlinear optical crystal based on two-photon absorption, including the following steps:
irradiating the nonlinear optical crystal by a laser, where the laser has a photon energy of Eg/2 to Eg, Eg being a band gap of the nonlinear optical crystal.

In some embodiments, the laser has a wavelength of 165 nm to 305 nm.

In some embodiments, the laser has the wavelength of 266 nm.

In some embodiments, the laser is generated by a laser device, and the laser device is selected from the group consisting of a solid-state laser device and an excimer laser device.

In some embodiments, the nonlinear optical crystal includes one selected from the group consisting of potassium dihydrogen phosphate, deuterated potassium dihydrogen phosphate or ammonium dihydrogen phosphate.

In some embodiments, the laser has a pulse width of 0.3 ns to 40 ns or 100 fs to 100 ps.

In some embodiments, the laser has a spot diameter of 0.05 mm to 5 mm.

In some embodiments, a power density of the laser is 0.2 times to 1.5 times a bulk damage threshold of the nonlinear optical crystal, and the bulk damage threshold of the nonlinear optical crystal is a bulk damage threshold corresponding to a wavelength of a conditioned laser.

In some embodiments, a pulses number of the laser is 90% to 95% of a saturated pulses number.

In some embodiments, the nonlinear optical crystal is deuterated potassium dihydrogen phosphate; the laser has a wavelength of 266 nm, a pulse width of 10 ns, a spot diameter of 1 mm, and a power density of 0.13 GW/cm².

The present disclosure provides a laser conditioning method for a nonlinear optical crystal based on two-photon absorption, including the following steps: irradiating a nonlinear optical crystal by a laser, where the laser has a photon energy of Eg/2 to Eg, Eg being a band gap of the nonlinear optical crystal. Since a laser with a wavelength of 355 nm is used for laser conditioning in the prior art, valence band electrons of the nonlinear optical crystal must absorb three photons at the same time before being ionized to a conduction band, which is a third-order nonlinear process. In the present disclosure, the laser with a photon energy of Eg/2 to Eg is used for conditioning, and valence band electrons of the nonlinear optical crystal only need to absorb two photons at the same time before being ionized to a conduction band, which is a second-order nonlinear process. Because the probability of two-photon absorption is thousand times to tens of thousands times higher than that of three-photon absorption, compared with laser conditioning based on three-photon absorption at present, in the present disclosure the laser conditioning method by using the laser with a photon energy of Eg/2 to Eg, that is, based on two-photon absorption, has greatly improved efficiency. As can be seen from the results of examples and comparative examples, in the present disclosure, the laser with a wavelength of 266 nm, which is much weaker (more than 10 times) than that with a wavelength of 355 nm, is used for conditioning, and under the condition that a laser power density is only 0.13 GW/cm², the zero-probability bulk damage threshold of the DKDP crystal is 4.7 J/cm² after conditioning, which is 120% higher than the zero-probability bulk damage threshold of 2.3J/cm² before conditioning. Compared with the fact that the laser intensity of 4 GW/cm² to 5 GW/cm² is required in the prior art to obtain the same conditioning effect (the bulk damage threshold is improved by about one time), the laser power density in the present disclosure is obviously reduced, thereby improving the conditioning efficiency and reducing the conditioning cost. Moreover, compared with three-photon absorption laser conditioning, the laser conditioning of the KDP crystal based on two-photon absorption according to the present disclosure not only has higher conditioning efficiency, but also has greater potential in improving a crystal bulk damage threshold.

### BRIEF DESCRIPTION OF THE DRAWINGS

FIG. 1 is a schematic flow chart of laser conditioning of a DKDP crystal based on two-photon absorption according to an embodiment of the present disclosure.

FIG. 2 is a schematic diagram of an experimental optical path system of quadruple-frequency laser conditioning of a DKDP crystal based on two-photon absorption according to an embodiment of the present disclosure.

FIG. 3 is a schematic diagram of a bulk damage probability curve of a crystal measured by a small-aperture laser and an optical path system of triple-frequency laser conditioning.

FIG. 4 is an electron paramagnetic resonance spectrogram of a DKDP crystal before and after laser conditioning in Embodiment 1.

FIG. 5 is a measurement result diagram of a damage probability curve of a DKDP crystal before and after laser conditioning in Example 1 and Comparative Example 1.

### DETAILED DESCRIPTION OF THE EMBODIMENTS

The present disclosure provides a laser conditioning method for a nonlinear optical crystal based on two-photon absorption, including (or consisting of) the following steps:
irradiating a nonlinear optical crystal by a laser, where the laser has a photon energy of Eg/2 to Eg, Eg being a band gap of the nonlinear optical crystal.

In the present disclosure, unless otherwise specified, all preparation raw materials/components are commercially available products well-known to those skilled in the art.

According to present disclosure, based on the physical phenomenon of two-photon absorption of the crystal, the nonlinear optical crystal is subjected to laser conditioning, greatly and efficiently increasing the laser bulk damage threshold of these crystals, where the nonlinear optical crystal includes one selected from the group consisting of potassium dihydrogen phosphate (KDP) nonlinear optical crystals and similar crystals with lattice structures similar to KDP. In some embodiments, the similar crystals includes (or is) one selected from the group consisting of deuterated potassium dihydrogen phosphate (DKDP) and ammonium dihydrogen phosphate (ADP) and the like.

There are no special requirements on the preparation method of the nonlinear optical crystal, and the nonlinear optical intraocular lens which is well-known to those skilled in the art and is obtained through artificial growth and annealing processing may be used. In some embodiments, prior to the irradiation, the nonlinear optical crystal is subjected to cutting and surface polishing in sequence. There are no special requirements on the specific implementation of the cutting and surface polishing. In some embodiments, the cutting is carried out according to the direction and size required when the nonlinear optical crystal is used. In some embodiments, the surface of the nonlinear optical crystal obtained after surface polishing achieves the optical grade smoothness.

In some embodiments, the nonlinear optical crystal includes one selected from the group consisting of potassium dihydrogen phosphate (KDP), deuterated potassium dihydrogen phosphate (DKDP) or ammonium dihydrogen phosphate (ADP). In some embodiments, the deuterated ratio of the DKDP is in a range of 5% to 98%. In a specific embodiment of the present disclosure, the DKDP is taken as an example to illustrate the laser conditioning method according to the present disclosure in detail. The deuterated ratio of the DKDP crystal is 70%. The DKDP crystal is an insulator with a large band gap (Eg). The band gap of the DKDP crystal is in a range of 7.5 ev to 9 ev.

In some embodiments, the laser is generated by a laser device. The laser device is selected from the group consisting of a solid-state laser device and an excimer laser device. In further embodiments, the laser device is a solid-state laser device. Compared with the excimer laser device, the solid-state laser device is more environment-friendly. In the present disclosure, the solid-state laser device is preferably used for laser conditioning of the nonlinear optical crystal. The conditioning process is green and environment-friendly, and suitable for wide industrial application. In a specific embodiment of the present disclosure, the laser device used in the laser conditioning is an Nd: YAG laser device. The pulse width of the Nd: YAG laser device is nanosecond to sub-nanosecond, which could output quadruple-frequency laser with high efficiency.

In some embodiments, the photon energy (hv) of the laser is in a range of Eg/2 to Eg. The laser photons with the photon energy of Eg/2 to Eg could ionize valence band electrons in the nonlinear optical crystal to the conduction band of the crystal through the two-photon absorption process of the nonlinear optical crystal. The nonlinear optical crystal is irradiated by a laser with a certain number of pulses at a laser intensity lower than its bulk damage threshold, and the bulk damage threshold of the nonlinear optical crystal is greatly and efficiently improved.

In some embodiments, the wavelength of the laser is in a range of 165 nm to 305 nm, preferably 175 nm to 295 nm, and more preferably 205 nm to 275 nm. In a specific embodiment of the present disclosure, the laser has a wavelength of 266 nm. In some embodiments, the quadruple-frequency laser used herein has a wavelength of 266 nm, a photon energy of 4.66 eV, and a photon energy between 3.75 ev and 7.5 ev, thus meeting the requirement of photon energy for laser conditioning of the DKDP crystal based on two-photon absorption.

In some embodiments, the pulse width of the laser is in a range of 0.3 ns to 40 ns or 100 fs to 100 ps, preferably 5 ns to 40 ns or 150 fs to 80 ps, and more preferably 15 ns to 30 ns or 500 fs to 50 ps. In some embodiments, the spot diameter of the laser is in a range of 0.05 mm to 5 mm, preferably 0.1 mm to 5 mm, and more preferably 1 mm to 5 mm. In some embodiments, the power density of the laser is 0.2 times to 1.5 times the bulk damage threshold of the nonlinear optical crystal, preferably 0.3 times to 1.5 times the bulk damage threshold of the nonlinear optical crystal, more preferably 0.4 to 1.5 times the bulk damage threshold of the nonlinear optical crystal, and most preferably 0.5 to 1.5 times the bulk damage threshold of the nonlinear optical crystal. The bulk damage threshold of the nonlinear optical crystal is a bulk damage threshold corresponding to the wavelength of the conditioned laser. In some embodiments, the bulk damage threshold of the nonlinear optical crystal to be conditioned varies with the wavelength of the conditioned laser. In some embodiments, the power density of the laser is 0.2 times to 1.5 times the bulk damage threshold of the nonlinear optical crystal. The bulk damage threshold means the bulk damage threshold of the nonlinear optical crystal corresponding to the wavelength of the conditioned laser.

In a specific embodiment of the present disclosure, the power density of the laser is 0.565 times the bulk damage threshold of the nonlinear optical crystal. In some embodiments, the bulk damage threshold of the nonlinear optical crystal is the maximum lase power density (in unit of W/cm²) when the nonlinear optical crystal is irreversibly damaged by laser irradiation before conditioning. In some embodiments, before the laser conditioning, the nonlinear optical crystal to be conditioned is evaluated and calculated to obtain its bulk damage threshold. In some embodiments, the pulse number of the laser is in a range of 90% to 95% of the saturated pulse number, and preferably 95% of the saturated pulse number. In the present disclosure, in the laser conditioning process, the bulk damage threshold of the nonlinear optical crystal is gradually increased with the increase of the laser pulse number, but after the laser pulse number reaches a certain value, the bulk damage threshold of the nonlinear optical crystal is no longer increased to be saturated when the laser pulse number is increased again. In the present disclosure, the saturated pulse number is defined as a laser pulse number that the bulk damage threshold of the nonlinear optical crystal is no longer increased with the increase of the laser pulses number in the laser conditioning process.

In a specific embodiment of the present disclosure, the nonlinear optical crystal is deuterated potassium dihydrogen phosphate; the laser has a wavelength of 266 nm, a pulse width of 10 ns, a spot diameter of 1 mm, a power density of 0.13 GW/cm², and a pulses number of 5. The pulses number is the number of laser pulses from which the nonlinear optical crystal receive laser pulse irradiation at the same position. The pulses number is 5, which means that the number of laser pulses from which the nonlinear optical crystal receive laser pulse irradiation at the same position is 55.

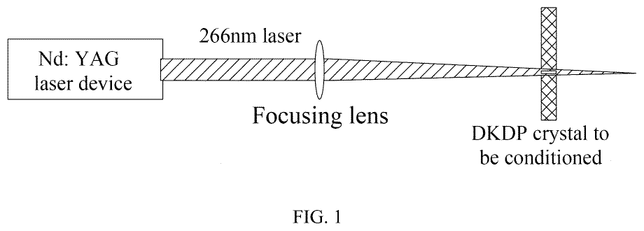

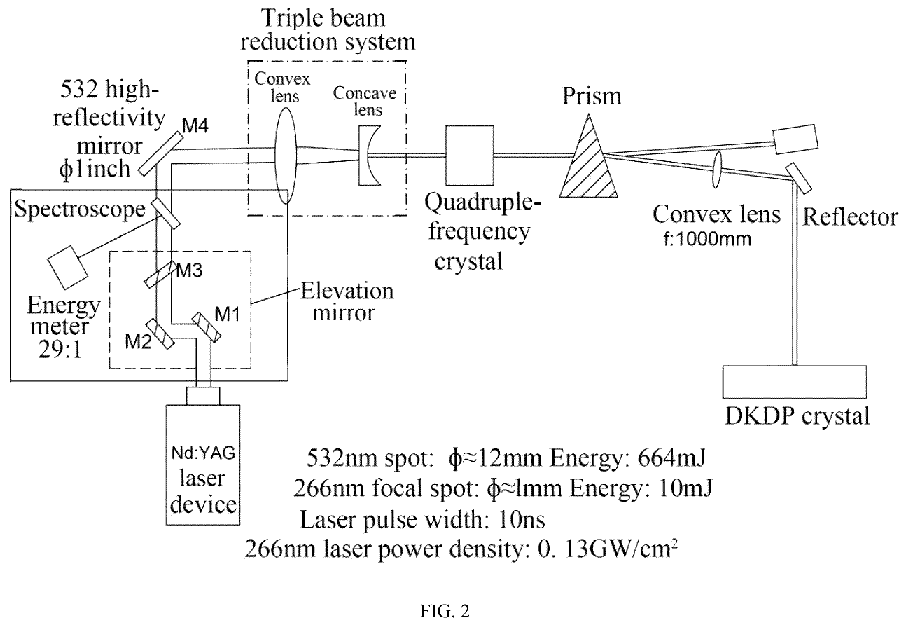

In a specific embodiment of the present disclosure, a schematic flow chart of the laser conditioning process for the nonlinear optical crystal is shown in FIG. 1, and a schematic diagram of the optical path system is shown in FIG. 2. As shown in FIG. 2, the optical path system used in the laser conditioning system according to the present disclosure consists of a laser device and an optical path transmission and adjustment system, wherein: the laser device is an Nd: YAG laser device; the optical path transmission and adjustment system consists of an elevation mirror, a spectroscope, a 532 high-reflectivity mirror, a triple beam reduction system, a quadruple-frequency crystal, a prism, a convex lens and a reflector in sequence. In a specific embodiment of the present disclosure, as shown in FIG. 2, the ultraviolet laser of 266 nm output by the Nd: YAG laser device is focused by focusing lens with a long focal length and is incident on the nonlinear optical crystal to be conditioned. Usually, the area of the crystal to be conditioned is much larger than that of the laser spot. In some embodiments, the whole crystal is subjected to conditioning to be uniform by a laser spot scanning method.

In the present disclosure, the selection of the photon energy of the laser is the key to improve the laser bulk damage threshold of the nonlinear optical crystal significantly and efficiently. In the prior art when a triple-frequency laser with a wavelength of 355 nm is used for laser conditioning, valence band electrons of the nonlinear optical crystal must absorb three photons at the same time before being ionized to a conduction band, which is a third-order nonlinear process. In the present disclosure, a quadruple-frequency laser with a wavelength of 266 nm is used for laser conditioning; valence band electrons of the nonlinear optical crystal only need to absorb two photons at the same time before being ionized to a conduction band, which is a second-order nonlinear process. Because the probability of two-photon absorption is thousand times to tens of thousand times higher than that of three-photon absorption, compared with laser conditioning based on three-photon absorption at present, the laser conditioning technology based on two-photon absorption according to the present disclosure could greatly improve the efficiency of laser conditioning.

In order to further illustrate the present disclosure, the technical solutions of the present disclosure are described in detail in conjunction with examples below, but these examples should not be understood as limiting the scope of the present disclosure.

### Example 1

DKDP crystal (with a deuterated ratio of 70%) was subjected to laser conditioning according to the flow chart of laser conditioning shown in FIG. 1 and the optical path diagram shown in FIG. 2, where the laser conditioning was conducted as follows.

An artificially grown DKDP crystal which had been processed by a thermal annealing process was selected, and then cut according to the direction and the size required for the application of the crystal. After that, a cut crystal was subjected to surface polishing to make the surface achieve an optical grade smoothness.

The ultraviolet laser with 266 nm output by the Nd: YAG laser device was focused by a focusing lens with a long focal length, and was incident on the DKDP crystal to be conditioned. The whole crystal was subjected to conditioning to be uniform by a laser spot scanning manner. During the conditioning, the laser parameters were as follows: the wavelength of 266 nm, the spot diameter of 1 mm, the power density of 0.13 GW/cm², the pulse number of 5 (the DKDP crystal is irradiated by five laser pulses at the same position), the pulse width of 10 ns, and the fluence of 1.3 J/cm².

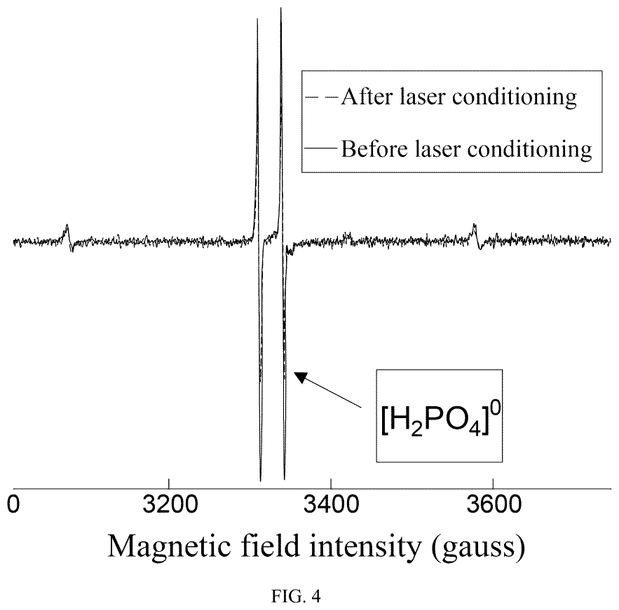

In Example 1, the number of intrinsic “point defects” of the DKDP crystal before and after the laser conditioning was measured relatively by an electron paramagnetic resonance spectrometer with a microwave frequency of 9.4 GHz at a sample temperature of 30K. The obtained electron paramagnetic spectrum is shown in FIG. 4. In FIG. 4, the solid curve represents the spectrum of the crystal without laser conditioning, and the dashed curve represents the spectrum of the crystal after laser conditioning. As can be seen from FIG. 4, the number of hole-type “point defects” [H₂PO₄]⁰ directly related to the laser bulk damage threshold after laser conditioning is reduced to only 60% of the point defects before laser conditioning.

### Comparative Example 1

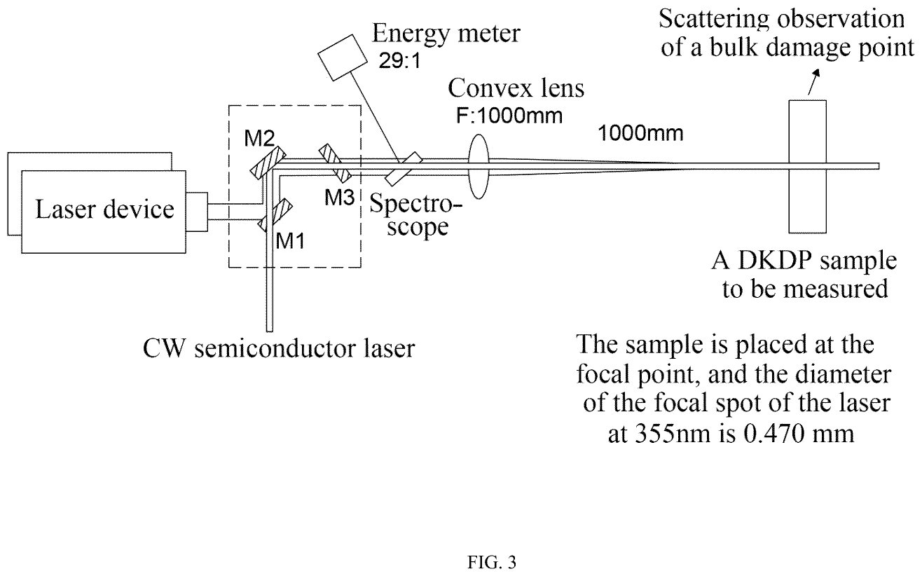

DKDP crystal was subjected to laser conditioning according to the flow chart of laser conditioning shown in FIG. 1 and the optical path diagram shown in FIG. 3; where the optical path diagram shown in FIG. 3 is not only suitable for measuring the damage probability curve, but also suitable for laser conditioning by using a laser with 355 nm. The laser conditioning was conducted as follows.

An artificially grown DKDP crystal which had been processed by a thermal annealing process was selected, and then cut according to the direction and the size required for the application of the crystal. After that, a cut crystal was subjected to surface polishing to make the surface achieve an optical grade smoothness.

The ultraviolet laser with 355 nm output by the Nd: YAG laser device was focused by a focusing lens with a long focal length, and was incident on the DKDP crystal to be conditioned. The whole crystal was subjected to conditioning to be uniform by a laser spot scanning manner. During the conditioning, the laser parameters were as follows: the wavelength of 355 nm, the spot diameter of 1 mm, the power density of 0.1 GW/cm², the pulse number of 5 (the DKDP crystal is irradiated by five laser pulses at the same position), the pulse width of 10 ns, and the fluence of 1.0 J/cm².

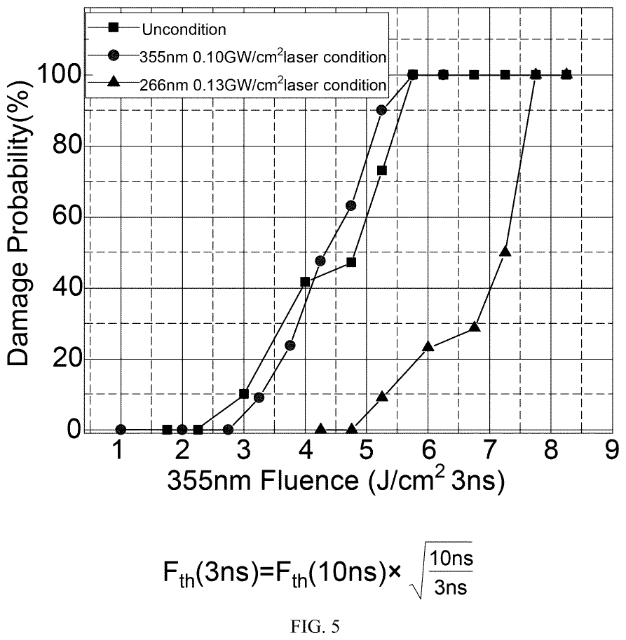

In Example 1 and Comparative Example 1, the DKDP crystals before and after laser conditioning were tested according to the optical path diagram of the bulk damage probability curve of the crystal measured by the small-aperture laser as shown in FIG. 3. The test results are shown in FIG. 5. FIG. 5 shows the damage probability curves of the DKDP crystals before and after laser conditioning in Example 1 and Comparative Example 1. It can be concluded from FIG. 5 that the zero-probability bulk damage threshold of the DKDP crystal before laser conditioning is 2.3 J/cm², the zero-probability bulk damage threshold of the DKDP crystal after quadruple-frequency conditioning in Example 1 is 4.7 J/cm², and the zero-probability bulk damage threshold of the DKDP crystal after triple-frequency conditioning in Comparative Example 1 is 2.7 J/cm². After comparing the results of Example 1 and Comparative Example 1, it can be seen that when the laser pulse width is the same, and the laser power (intensity) is almost the same, but the laser wavelength is different, the zero-probability bulk damage threshold of the crystal conditioned by 266 nm laser based on two-photon absorption in Example 1 is increased by 120%, while the zero-probability bulk damage threshold of the crystal conditioned by 355 nm laser based on three-photon absorption in Comparative Example 1 is only increased by 20%. FIG. 5 proves the effectiveness of an efficient laser conditioning method for a nonlinear optical crystal based on two-photon absorption according to the present disclosure. Further, in this example, the laser with a wavelength of 266 nm, which is much weaker (more than 10 times) than 355 nm, is used for conditioning, and under the condition that a laser power density is only 0.13 GW/cm², it is observed that the zero-probability bulk damage threshold of the DKDP crystal is 4.7 J/cm² after conditioning, which is 120% higher than the zero-probability bulk damage threshold of 2.3 J/cm² before conditioning. Compared with Comparative Example 1, the conditioning method according to Example 1 of the present disclosure has a remarkable effect of improving the bulk damage threshold of the crystal, and achieves the same conditioning effect as that in the prior art (the bulk damage threshold is improved by about one time). According to the present disclosure, the laser power density (0.13 GW/cm²) of the laser with a wavelength of 266 nm is only a several tenths of that (4 GW/cm² to 5 GW/cm²) of the laser with a wavelength of 355 nm, thereby improving the laser conditioning efficiency and reducing the conditioning cost. Finally, the laser conditioning of the KDP crystal based on two-photon absorption according to the present disclosure not only has higher conditioning efficiency than that of three-photon absorption laser conditioning, but also has greater potential in improving a crystal bulk damage threshold than that of three-photon absorption laser conditioning. Such potential lies in the ability to obtain higher conduction band electron density when laser conditioning based on two-photon absorption is used.

Although the present disclosure is described in detail according to the above-mentioned examples, the examples are only some of the embodiments of the present disclosure, rather than all of the embodiments. Other embodiments could be obtained without creative effort according to these embodiments, which all belong to the scope of the present disclosure.

1. A laser conditioning method for a nonlinear optical crystal, comprising the following steps:
irradiating the nonlinear optical crystal by a laser, wherein the laser has a photon energy of Eg/2 to Eg, Eg bing a band cap of the nonlinear optical crystal.

2. The laser conditioning method according to claim 1, where in the laser has a wavelength of 165 nm to 305 nm.

3. The laser conditioning method according to claim 2, wherein the laser has the wavelength of 266 nm.

4. The laser conditioning method according to claim 1, wherein the laser is generated by a laser device, and the laser device is selected from the group consisting of a solid-state laser device and an excimer laser device.

5. The laser conditioning method according to claim 1, wherein the nonlinear optical crystal comprises one selected from the group consisting of potassium dihydrogen phosphate, deuterated potassium dihydrogen phosphate, and ammonium dihydrogen phosphate.

6. The laser conditioning method according to claim 1, wherein the laser has a pulse width of 0.3 ns to 40 ns or 100 fs to 100 ps.

7. The laser conditioning method according to claim 1, wherein the laser has a spot diameter of 0.05 mm to 5 mm.

8. The laser conditioning method according to claim 1, wherein a power density of the laser is 0.2 times to 1.5 times a bulk damage threshold on the nonlinear optical crystal, and the bulk damage threshold of the nonlinear optical crystal is a bulk damage threshold corresponding to a wavelength of a conditioned laser.

9. The laser conditioning method according to claim 1, wherein a pulse number of the laser is 90% to 95% of a saturated pulses number.

10. The laser conditioning method according to claim 1, wherein the nonlinear optical crystal is deuterated potassium dihydrogen phosphate; the laser has a wavelength of 266 nm, a pulse width of 10 ns, a spot diameter of 1 mm, and a power density of 0.13 GW/cm².

11. The laser conditioning method according to claim 2, wherein the laser is generated by a laser device, and the laser device is selected from a group consisting of a solid-state laser device and an excimer laser device.

12. The laser conditioning method according to claim 5, wherein a power density of the laser is 0.2 times to 1.5 times a bulk damage threshold of the nonlinear optical crystal, and the bulk damage threshold of the nonlinear optical crystal is a bulk damage threshold corresponding to a wavelength of a conditioned laser.

13. The laser conditioning method according to claim 5, wherein a pulse number of the laser is 90% to 95% of a saturated pulses number.
